(19) United States
(12) Patent Application Publication
(10) Pub. No.: US 2025/0001795 A1
(43) Pub. Date: Jan. 2, 2025

(54) Erasably Writeable Novelty Item

(71) Applicant: Doood Pty Ltd, Richmond (AU)

(72) Inventor: Beatrice Toh

(21) Appl. No.: 18/221,093

(22) Filed: Jul. 12, 2023

(30) Foreign Application Priority Data
Jun. 27, 2023 (AU) 2023204087

(51) Int. Cl. B43L 1/00; B42D 15/00

(52) U.S. Cl. CPC B43L 1/00; B42D 15/008; B42D 15/0093

(57) ABSTRACT

A novelty item for the amusement of children, said item including a plurality of mats made from a flexible material that is adapted to receive erasable ink markings; wherein said mats are linked in an array and foldably connected along a straight edge, thereby to enable the folding of said array of mats into a compact form wherein all of said mats will lay flat and aligned; wherein said foldable connections are debossed trenches extending fully across at least one surface of said mats.

### TECHNICAL FIELD

The invention relates to the field of manufacture of playthings and toys for children. In particular, the invention relates to an improved construction of a writeable and erasable book to be used by children.

### BACKGROUND OF THE INVENTION

The activity of ‘colouring in’, where colours are applied to e.g., a printed drawing on a page, has long been a popular pastime mainly for children, although increasing in popularity for adults in recent times.

The traditional medium for this has been a black line drawing of an object, character or scene printed on paper. The drawing is then coloured by pencils, crayons, ink, paints or the like. These can be formed in to books, and the books may hold a loosely connected series of images in a collection, or they may contain a sequential set of images that represent a story. The traditional paper colouring book has provided hours of amusement and creativity for their users.

Such books are often transported by patents or carers on outings as they provide a ready and simple for of amusement for children while away from the home.

However, paper is a ‘single use’ medium for this type of activity. Accordingly, there have been developed re-usable versions of colouring-drawings. Typically, these take the form of a mat with permanently printed drawings, where the mat is made of a material that, in combination with use of a non-permanent ink, makes the individual's colouring readily erasable.

Typically, a printed silicone has been used for the mat and dry-erase inks, such as those used for whiteboard markers, is used to colour the printed image. The colouring can then be erased by wiping with e.g., a cloth and the same printed drawing on the silicone mat can re-used.

However, the storage and transport of such mats when not in use creates some difficulties. Folding the mat can cause damage and rolling the mat increases its stored or transported volume of the mat and prevents it from being stored flat.

Also, such mats are not readily amenable for use in colouring books, being limited to a single sheet. Attempts have been made to create silicone ‘books’, but it is a difficult material to bind, especially in a manner that will allow successive leaves of the book to lay flat and even. If one makes the silicone too thin, it becomes liable to tearing damage when handled by children.

Typical book binding techniques, such as sewing, stapling and ring-binding, do not produce a reliably foldable corner with materials like silicone. They also do not give the required aesthetic desired by the inventor.

Accordingly, it is an object of the invention to provide a that provides an erasable colouring book that will be more compact to transport and/or is presentable in the form of a book by ameliorating at least some of the problems associated with the prior art.

### SUMMARY OF THE INVENTION

The invention is essentially an array of panels made from a flexible, erasable material that are joined in a manner that facilitates the array to be folded in a flat form and to be unfolded in a manner resembling a book. The surface of the panels can be printed for use as a colouring in surface.

The invention also resides in a method of creating such an array from a sheet of said flexible material.

According to a first aspect of the invention, there is provided a novelty item for the amusement of children, said item including a plurality of mats made from a flexible material, preferably silicone, that is adapted to receive erasable ink markings; wherein said mats are linked in an array and foldably connected along a straight edge, thereby to enable the folding of said array of mats into a compact form wherein all of said mats will lay flat and aligned; wherein said foldable connections are debossed trenches extending fully across at least one surface of said mats.

Preferably, the thickness of said flexible material in the debossed trenches is between 20% and 30% of the thickness of said flexible material. More preferably, the thickness of said flexible material in the debossed trenches is approximately 25% of the thickness of said flexible material.

Preferably, the width of said debossed trenches is at least 1.5 times the thickness of said flexible material.

The above described features provide an array of printable and erasably writeable panels that can be folded flat in to the width of one panel without appreciable bulging at the folded edges, which makes them ideal for folding into a book-like configuration that can be operated like a conventional book by turning ‘pages’ composed of consecutive panels. It also has a compact shape for easy packing and transport in a tote bag, handbag or the like. The features also allow the array to be resistant to tearing along the fold lines, making the array more durable when handled by young children.

According to another aspect of the invention, there is provided a method of manufacturing a novelty item for the amusement of children, said item including a foldable array of mats made from a flexible material; said mats being adapted to receive erasable ink markings; said method including the steps of: debossing a plurality of trenches into at least one surface of said mats; wherein said trenches are between 20% and 30% of the thickness of said flexible material and wherein said debossed trenches have a width of at least 1.5 times the thickness of said flexible material.

Now will be described, by way of a specific, non-limiting example, a preferred embodiment of the invention with reference to the drawings.

### BRIEF DESCRIPTION OF THE DRAWINGS

FIG. 1 shows a view of a novelty item according to the invention in an unfolded configuration.

FIG. 2 shows a view of a novelty item according to the invention in a partly folded configuration.

FIG. 3 shows a view of a novelty item according to the invention in a fully folded configuration.

FIG. 4 shows a close-up view of the geometry of the folding trenches of a novelty item according to the invention.

### DETAILED DESCRIPTION OF THE INVENTION

The invention may be exemplified by a foldable array of connected or integrally formed mats or pads that are capable of being written or drawn upon with erasable inks and are capable of having permanent images printed on them to be used for colouring-in, wherein the folding areas conform with the invention, so as to enable the array to be folded in a flat manner and easily unfolded.

In the example described below, reference is made to the appended figures.

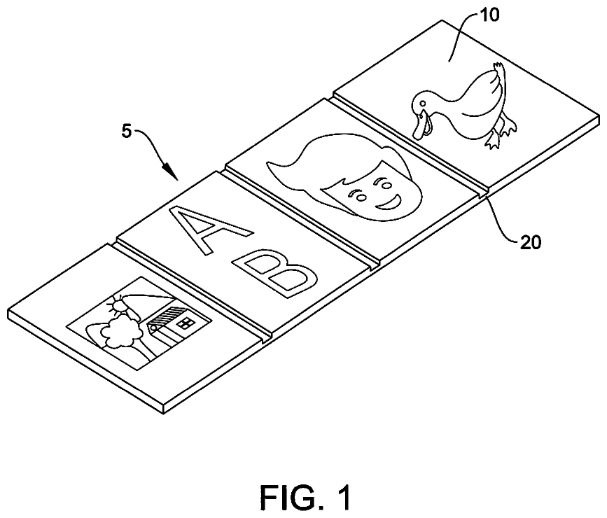

Turning to FIG. 1, there is shown an array 5 made from a silicone rubber sheet. In this example, the sheet is made from a food grade silicone as supplied by Hoshine Silicon Industry Co. Ltd. Of Pinghu City, Zhejiang Province in China. This material has appropriate physical properties for the present use, including that it can receive both permanent printing of pictures as well as erasable colouring ink.

The sheet has a thickness of 1.68 mm and an approximate total size of 150 mm by 150 mm, while other sized are of course possible. The sheet is divided into six equally sized mats 10 by five folding zones 15.

Each mat 10 has an appealing or amusing figure or scene printed on it in outlines, to encourage the user to draw on and/or colour-in the figures.

Each of the folding zones is a trench 20 that is formed in the surface of the silicone, for example by debossing. According to the invention, the trenches have a width of 1.5 times (or more) of the thickness of the silicone sheet and a depth of between 70% to 80% of the thickness of said sheet. The trenches run parallel to the sides of the sheet.

In this example, the silicone sheet has a thickness of approximately 1.68 mm and the trench 20 has a width of 3 mm and a depth of 1.25 mm, making the thickness of the silicone at the folding zone approximately 0.43 mm. Silicone thickness of between 1 mm and 2 mm is typically ideal.

These trench dimensions have been found by the inventors to provide a reliable folding ability for the mats 10 of the array, where successive folded mats will lay flat upon one another, without stretching or bulging at the folded edges. They have also found that it is very difficult to physically tear off adjoining mats, making the array much more durable for use with young children.

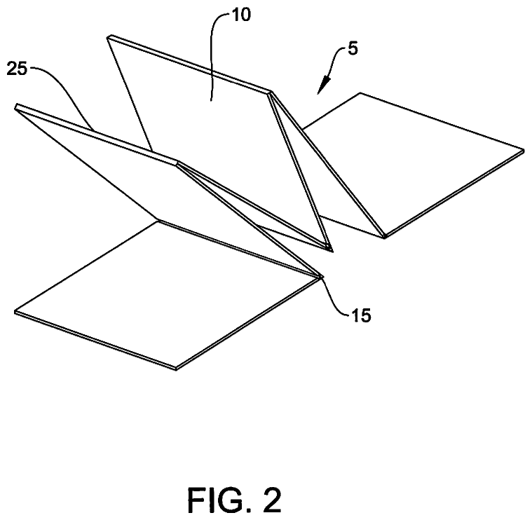

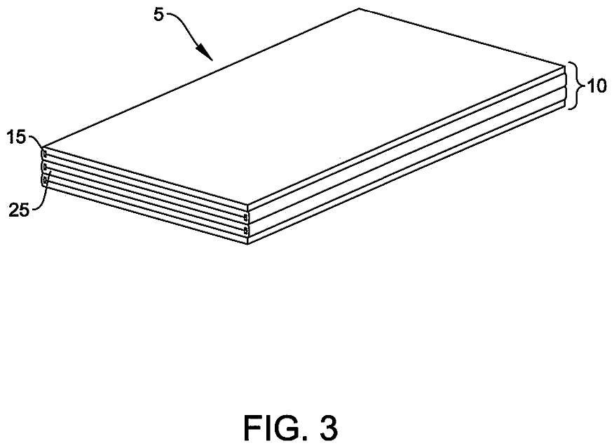

This is further exemplified in FIGS. 2 and 3. In FIG. 2, the array 5 is shown in a state of partial folding/unfolding. By unfolding the array 5 in the way shown, it is possible to open successive facing mats like opening the facing pages of a book. Alternatively, the array can be completely unfolded, as shown in FIG. 1.

In FIG. 3, the array 5 is shown in a completely folded state. It will be noted that the folded edges 25 do not bulge and that each folded mat 10 in the array lies wholly and directly on the adjoining mat, without evident twisting or misalignment.

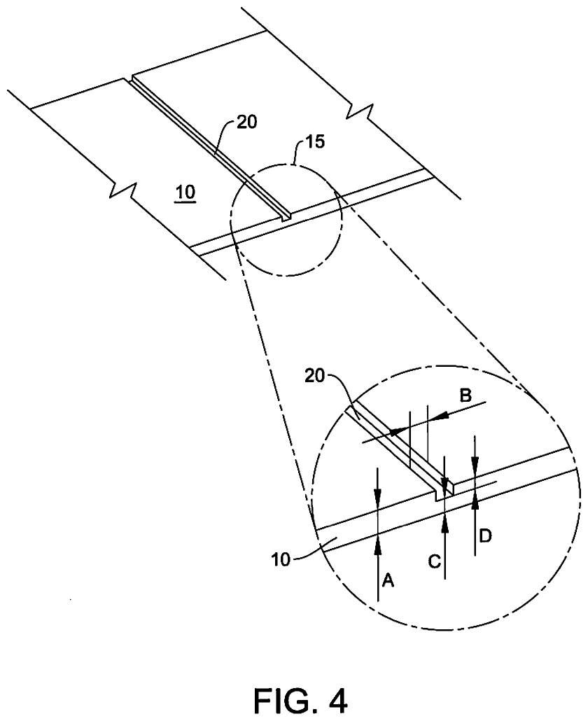

In FIG. 4, there is shown in greater detail the geometry of the folding zone and specifically the dimensions of the trench 20. The thickness of the silicone sheet is A and the width of the trench 20 is B. The depth of the trench D renders the thickness C of the sheet under the trench 20, such that A=C+D. The thickness C is preferably between 0.2×A and 0.3×A.

The trench width D is at least 1.5×C.

The array is made by sizing a sheet of silicone to the desired dimensions, and debossing the trenches, as described above, into the surface of the silicone at the desired folding zones. The debossing process is well known in the art and may be done, for example, by applying a heated mould sized to the dimensions of the trench and with pressure onto the sheet.

Alternatively, the silicone sheet may be moulded with the desired folding zone geometry already established in the mould itself.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. A novelty item for the amusement of children, said item including a plurality of mats made from a flexible material that is adapted to receive erasable ink markings; wherein said mats are linked in an array and foldably connected along a straight edge, thereby to enable the folding of said array of mats into a compact form wherein all of said mats will lay flat and aligned; wherein said foldable connections are debossed trenches extending fully across at least one surface of said mats.

2. The novelty item of claim 1, wherein the thickness of said flexible material in the debossed trenches is between 20% and 30% of the thickness of said flexible material.

3. The novelty item of claim 2, wherein the thickness of said flexible material in the debossed trenches is approximately 25% of the thickness of said flexible material.

4. The novelty item of claim 1 wherein the width of said debossed trenches is at least 1.5 times the thickness of said flexible material.

5. A method of manufacturing a novelty item for the amusement of children, said item including a foldable array of mats made from a flexible material; said mats being adapted to receive erasable ink markings; said method including the steps of: debossing a plurality of trenches into at least one surface of said mats; wherein said trenches are between 20% and 30% of the thickness of said flexible material and wherein said debossed trenches have a width of at least 1.5 times the thickness of said flexible material.
